(19) United States
(12) Patent Application Publication
(10) Pub. No.: US 2025/0073592 A1
(43) Pub. Date: Mar. 6, 2025

(54) PROGRAM, INFORMATION PROCESSING APPARATUS, METHOD AND SYSTEM

(71) Applicant: CYGAMES, INC., Tokyo (JP)

(72) Inventors: Kenichiro Takaki, Tokyo (JP); Azuri Araki, Tokyo (JP); Masato Kaeriyama, Tokyo (JP)

(73) Assignee: CYGAMES, INC., Tokyo (JP)

(21) Appl. No.: 18/949,377

(22) Filed: Nov. 15, 2024

Related U.S. Application Data
(63) Continuation of application No. PCT/JP2023/017894, filed on May 12, 2023.

(30) Foreign Application Priority Data
May 20, 2022 (JP) 2022-082787

(51) Int. Cl. A63F 13/58; A63F 13/69; A63F 13/822

(52) U.S. Cl. CPC A63F 13/58; A63F 13/69; A63F 13/822

(57) ABSTRACT

In a game system having multiple information processing apparatuses, at least one of the information processing apparatuses functions as a game executer that executes a competition game where groups compete against each other in a first game space, and at least one of the information processing apparatuses functions as a condition determiner that determines whether or not either of the groups satisfies a predetermined condition during the game. When the condition determiner determines that either of the groups satisfies the predetermined condition during the game, the game executer executes a competition game where the groups compete against each other in a second game space that is associated with each character in the group determined as having satisfied the predetermined condition and that is different from the first game space, and executes a favoring process on the group that has satisfied the predetermined condition in the competition game.

### TECHNICAL FIELD

The present invention relates to programs and so on, and particularly, to a program and so on for executing a game involving competition between groups including a plurality of characters.

### BACKGROUND ART

In a known competition game in the related art, a character can exercise a special technique in addition to a normal technique that the character can normally exercise.

### CITATION LIST

### Patent Literature

### [PTL 1]

Publication of Japanese Patent No. 6235669

### SUMMARY OF INVENTION

### Technical Problem

In the competition game in the related art, the character and the special technique are associated with each other, and the specialness of the character is enhanced by the special technique. However, in the competition game in the related art, the special technique to be exercised is limited to an extent that the attacking power increases relative to the normal technique. Thus, there is a demand to further enhance the specialness of the character.

The present invention has been made to solve this problem, and an object thereof is to provide a program, an information processing apparatus, a method, and a system that can endow a character with specialness and that can enhance the enjoyment of a game.

### Solution to Problem

A program according to an aspect of the present invention is a program for executing a game involving competition between groups including a plurality of characters and causes a computer to function as:
game executing means for executing a competition game where the groups compete against each other in a first game space; and
condition determining means for executing determination of whether or not either of the groups satisfies a predetermined condition during the game.

When the condition determining means determines that either of the groups satisfies the predetermined condition during the game, the game executing means executes a competition game where the groups compete against each other in a second game space that is associated with each character in the group determined as having satisfied the predetermined condition and that is different from the first game space, and executes a favoring process on the group that has satisfied the predetermined condition in the competition game.

The program according to an aspect of the present invention may have at least one of the following configurations [2] and [7] to [12]:
[2] the game includes a plurality of competition rounds each involving execution of the competition game, and
the predetermined condition includes a state where the competition round in which the condition determining means executes the determination is designated;
[7] in the configuration [2], the predetermined condition includes any of or a combination of at least two of
a state where the group serving as a target for the determination is designated before the competition round starts,
a state where the character serving as a target for the determination is designated before the competition round starts,
a state where a predetermined parameter that is of the character designated as the target for the determination before the competition round starts and that varies in accordance with an attack by the character in another group different from the group of the designated character is larger than or equal to a predetermined value before a predetermined time period lapses from when the competition round starts, and
a state where the number of times the determination is performed is smaller than or equal to a predetermined number of times for each group;
[8] the favoring process includes executing a technique exercisable only in the second game space based on an input by a player associated with the character in the group that has satisfied the predetermined condition;
[9] the game executing means ends the competition game after a predetermined time period lapses from when the competition game starts in the second game space, or ends the competition game after a predetermined time period lapses from when the competition game starts in the second game space and subsequently executes the competition game in the first game space;
[10] the computer is further caused to function as display control means for causing display means connected to the computer to display the competition game, and
the display control means causes the display means to display the competition game where the groups compete against each other in the second game space when the condition determining means determines that either of the groups satisfies the predetermined condition during the game;
[11] in the configuration [10], when the condition determining means determines that either of the groups satisfies the predetermined condition during the game,
the display control means causes the display means to display limitation points that increase or decrease in accordance with a status of the competition game in the second game space, and
the game executing means executes the competition game in the second game space, increases or decreases the limitation points in accordance with the status of the competition game, and ends the competition game in the second game space when the limitation points decrease to a predetermined value;
[12] each character is selectable by the player, and
all of the characters selectable in the game are each associated with the second game space unique to each character.

An information processing apparatus for a game according to an aspect of the present invention is an information processing apparatus for executing a game involving competition between groups including a plurality of characters and includes:
game executing means for executing a competition game where the groups compete against each other in a first game space; and
condition determining means for executing determination of whether or not either of the groups satisfies a predetermined condition during the game.

When the condition determining means determines that either of the groups satisfies the predetermined condition during the game, the game executing means executes a competition game where the groups compete against each other in a second game space that is associated with each character in the group determined as having satisfied the predetermined condition and that is different from the first game space, and executes a favoring process on the group that has satisfied the predetermined condition in the competition game.

A method according to an aspect of the present invention is a method in which an information processing apparatus executes a game involving competition between groups including a plurality of characters and includes:
a game executing step for executing a competition game where the groups compete against each other in a first game space; and
a condition determining step for executing determination of whether or not either of the groups satisfies a predetermined condition during the game.

When either of the groups is determined as having satisfied the predetermined condition during the game in the condition determining step, the game executing step involves executing a competition game where the groups compete against each other in a second game space that is associated with each character in the group determined as having satisfied the predetermined condition and that is different from the first game space, and executing a favoring process on the group that has satisfied the predetermined condition in the competition game.

A system according to an aspect of the present invention is a system for executing a game involving competition between groups including a plurality of characters.

The system has a plurality of information processing apparatuses.

At least one of the information processing apparatuses functions as game executing means for executing a competition game where the groups compete against each other in a first game space.

At least one of the information processing apparatuses functions as condition determining means for executing determination of whether or not either of the groups satisfies a predetermined condition during the game.

When the condition determining means determines that either of the groups satisfies the predetermined condition during the game, the game executing means executes a competition game where the groups compete against each other in a second game space that is associated with each character in the group determined as having satisfied the predetermined condition and that is different from the first game space, and executes a favoring process on the group that has satisfied the predetermined condition in the competition game.

### Advantageous Effects of Invention

The present invention can endow a character with specialness and can enhance the enjoyment of a game.

### BRIEF DESCRIPTION OF DRAWINGS

FIG. 1 illustrates an example of the overall configuration of a game system according to an embodiment of the present invention.

FIG. 2 is a block diagram illustrating the hardware configuration of each information processing apparatus.

FIG. 3 illustrates an example of a functional block diagram of the information processing apparatus.

FIG. 4 illustrates an example of a functional block diagram of a game control unit of a server.

FIG. 5 illustrates an example of a game screen indicating that a competition round is a first type of competition and involves competition in a first game space.

FIG. 6 illustrates an example of a game screen indicating that the competition round is a second type of competition and involves competition in the first game space before it is determined whether a predetermined condition is satisfied.

FIG. 7 illustrates an example of a game screen indicating that the competition round is the second type of competition and involves competition in a second game space when the predetermined condition is satisfied.

FIG. 8 illustrates another example of the game screen indicating that the competition round is the second type of competition and involves competition in the second game space when the predetermined condition is satisfied.

FIG. 9 illustrates an example of an operation flowchart of the game system according to the embodiment of the present invention.

### DESCRIPTION OF EMBODIMENTS

A game system according to an embodiment of the present invention will now be described with reference to the drawings. In this specification, descriptions that are more detailed than necessary may sometimes be omitted for the sake of convenience. For example, detailed descriptions about already known matters and redundant descriptions about substantially identical components may sometimes be omitted.

This game system may be realized by a system having a plurality of information processing apparatuses connected via a network, or may be realized by a plurality of information processing apparatuses communicating with each other without the intervention of a network. First, an embodiment realized by a system connected to a network will be described, and then, a system without the intervention of a network will be described.

[Embodiment Realized by System with Intervention of Network]

### [Schematic Configuration]

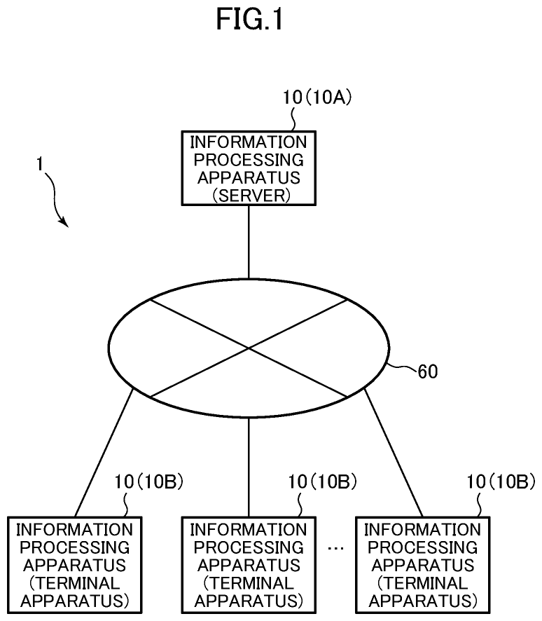

FIG. 1 illustrates an example of the overall configuration of the game system according to the embodiment of the present invention. As shown in FIG. 1, a game system 1 includes a plurality of information processing apparatuses 10. The information processing apparatuses 10 include a server and terminal apparatuses used by players. Specifically, in the case of a server, the information processing apparatus 10 is referred to as a “server 10A”. In the case of a terminal apparatus, the information processing apparatus 10 is referred to as a “terminal apparatus 10B”. One example of the information processing apparatus 10 is the server 10A, and another example of the information processing apparatus 10 is the terminal apparatus 10B. The server 10A and the terminal apparatuses 10B may each have hardware components of the information processing apparatus 10 and are communicatively connected to a network 60, such as the Internet. The game system 1 described in this embodiment is assumed to be a server-client system, or may be constituted of a system not equipped with the server 10A, as in a P2P (peer to peer) system.

The server 10A may be constituted of one or more computers that provide a game reproducible in each terminal apparatus 10B. Each terminal apparatus 10B is a consumer-oriented gaming apparatus in this embodiment, or may alternatively be a computer, such as a smartphone, a tablet-type computer, a notebook personal computer, or a desktop computer, so long as the terminal apparatus 10B includes the hardware components of the information processing apparatus 10.

The server 10A has stored therein various programs, such as a control program for controlling the progress of an online game, and various types of data used in the game. The server 10A exchanges data with each terminal apparatus 10B on a regular basis or where necessary, and allows the game to proceed.

In one example, each terminal apparatus 10B has preliminarily stored therein a game application program executable in the terminal apparatus 10B. Each terminal apparatus 10B receives an input (e.g., an operation) related to the game and transmits the input and/or information related to the input to the server 10A. The server 10A executes the game based on the received input and/or information related to the input, transmits an execution result thereof and information required for displaying it on the terminal apparatus 10B to the terminal apparatus 10B, and causes an output device 13 of the terminal apparatus 10B to display game-related information on a screen. The terminal apparatus 10B according to this embodiment can acquire the game application program by downloading it from the server 10A, or may alternatively read the game application program from a storage medium, such as a memory card or an optical disk, having the game application program stored therein.

In another example, the server 10A is a web server and provides a game service to each terminal apparatus 10B. The terminal apparatus 10B acquires HTML data for displaying the web page from the server 10A and displays the web page by analyzing the acquired HTML data. In this case, the server 10A communicating with the terminal apparatus 10B has all or some of the functions of a game control unit 25, to be described later.

### [Specific Configuration]

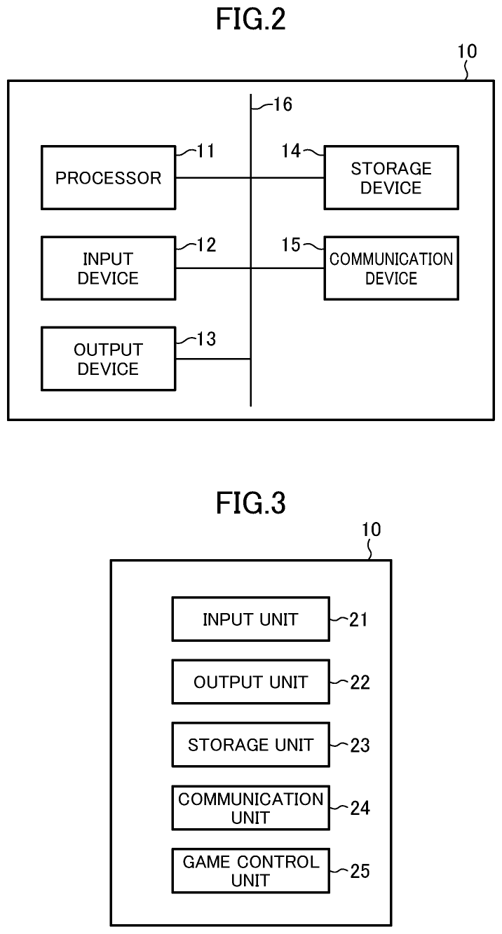

FIG. 2 is a block diagram illustrating the hardware configuration of each information processing apparatus 10. As shown in FIG. 2, the information processing apparatus 10 includes a processor 11, an input device 12, the output device 13, a storage device 14, and a communication device 15. The components 11 to 15 are connected to one another by a bus 16. An interface may intervene between the bus 16 and each of the components 11 to 15, where necessary.

The processor 11 controls the overall operation of the information processing apparatus 10 and is, for example, an electronic circuit, such as a CPU or an MPU. The processor 11 reads and executes a program and data stored in the storage device 14 to execute various processes. In one example, the processor 11 is constituted of a plurality of processors.

The input device 12 is a user interface that receives an input from a user using the information processing apparatus 10, and is, for example, a touch panel, a touchpad, a keyboard, or a mouse. In the case where the information processing apparatus 10 includes a touch panel, this touch panel can serve as a touchscreen so as to function both as the input device 12 and the output device 13. The input device 12 and the output device 13 may be disposed separately at different locations.

The output device 13 presents, for example, an application screen to the user, that is, a player, of the information processing apparatus 10 under the control of the processor 11. The output device 13 may include a display, such as a liquid crystal display, an organic EL display, or a plasma display, and a loudspeaker that outputs sound.

The storage device 14 includes a main memory, a buffer memory, and a storage unit and is a storage device that a typical smartphone or computer is equipped with. Examples include a storage device equipped with a RAM as a volatile memory, a storage device equipped with a flash memory, such as eMMC, UFS, or SSD, as a nonvolatile memory, and a magnetic storage device. The storage device 14 may include an external memory. The storage device 14 stores, for example, a game application. The game application includes a game program for executing the game and various types of data to be referred to during the execution of the game program. The game program is activated in response to an operation performed on the information processing apparatus 10 by the user and is executed in an operating system (OS) preliminarily installed in the information processing apparatus 10.

In one example, the storage device 14 includes a main storage device and an auxiliary storage device. The main storage device is a volatile storage medium from and to which information can be read and written at high speed, and is used as a storage area and a work area when the processor 11 processes information. The auxiliary storage device stores various programs and data to be used by each program when the program is executed. The auxiliary storage device is, for example, an SSD or a hard disk device, or may alternatively be any type of nonvolatile storage unit or nonvolatile memory or of a detachable type so long as the auxiliary storage device is capable of storing information. The auxiliary storage device stores, for example, the operating system (OS), middleware, application programs, and various types of data that may be referred to when any of these programs is executed.

The communication device 15 exchanges data with another computer, such as the server, or another information processing apparatus 10 via the network 60. For example, the communication device 15 performs wireless communication by means of mobile communication, wireless LAN, or so on to connect with the network 60. In one example, the information processing apparatus 10 downloads a program from the server via the communication device 15 and stores the program in the storage device 14. Alternatively, the communication device 15 may perform wired communication by using an Ethernet (registered trademark) cable. If data is not to be exchanged with another computer, the information processing apparatus 10 does not have to be equipped with the communication device 15.

FIG. 3 illustrates an example of a functional block diagram of the information processing apparatus 10. The information processing apparatus 10 includes an input unit 21, an output unit 22, a storage unit 23, a communication unit 24, and the game control unit 25. In this embodiment, these functions are realized as a result of the processor 11 executing a program. For example, the program to be executed is a game program stored in the storage device 14 or received via the communication device 15. Since the various functions are realized by reading the program in this manner, one part (function) may partially or entirely be included in another part. The functions are realized as respective means by executing the program. By configuring, for example, an electronic circuit for partially or entirely realizing each function, the function may be realized by hardware.

The input unit 21 is constituted by using the input device 12 and receives an input from the user using the information processing apparatus 10. The output unit 22 is constituted by using the output device 13 and presents game-related information to the user using the information processing apparatus 10. The storage unit 23 is constituted by using the storage device 14 and stores various types of game-related information and programs. The communication unit 24 is constituted by using the communication device 15 and functions as an interface for exchanging information with another information processing apparatus 10. The communication unit 24 transmits the input information received from the user by the input unit 21 to another information processing apparatus 10 via the network 60. The communication unit 24 also receives information from another information processing apparatus 10 and transmits the information to each unit.

The game control unit 25 performs basic control for executing the game according to this embodiment. The game control unit 25 is constituted by including the processor 11, executes the game, and causes the output device 13 to display a screen related to the game. The execution of the game by the game control unit 25 may include acquiring information required for the execution from the storage device 14, acquiring player operation information via the input device 12, the communication device 15, and/or the network 60, performing information processing on the game based on the required information, and generating and/or acquiring information required for causing the output device 13 to display the screen based on the information processing.

Next, the game and the game control unit 25 according to this embodiment will be described in detail.

### [Game]

The game according to this embodiment is a competition game involving competition between groups. Each group includes a plurality of characters, and each character is associated with a player. Specifically, the game according to this embodiment is a competition action game involving controlling a character corresponding to each player to execute an action, such as moving, attacking, defending, and/or recovering, and determining a win-loss result between the groups in accordance with the overall result of the action. Although each group includes a plurality of characters, at least one of the groups may include one character. Specifically, the competition game may include competition between a group including one character and a group including one or more characters.

The game according to this embodiment includes a plurality of competition rounds each involving execution of a competition game. Specifically, each competition round corresponds to a single competition game, and the win-loss result between the groups is determined for every competition round. Each competition round involves determining scores for the individual actions, determining a round score by adding together the determined scores for each group, and determining the win-loss result in the competition round based on the magnitude of the round score. For example, a group with the higher (or the highest) round score can be determined as the winner. A group with the larger (or the largest) number of wins in competition rounds may be determined as the winner group. The action may include setting a stamina parameter (HP) of an enemy character to zero or recovering the stamina parameter of an ally character.

The game does not necessarily have to include a plurality of competition rounds, and may involve determining the win-loss result between the groups in a single competition game. Furthermore, instead of determining the win-loss result for every competition round, the win-loss result between the groups may be determined based on the total of the round scores acquired in the competition rounds. The number of groups participating in a competition game may be three or more. In this embodiment, the number of groups participating in a competition game is two.

In the game according to this embodiment, the type of competition can be selected in each competition round. The type of competition may include a first type of competition and a second type of competition. The first type of competition is a competition game where groups compete against each other in a first game space, and is a normal competition in which each character can exercise a normal technique (i.e., a first type of technique (also referred to as “first technique” hereinafter)) associated with the character. The normal technique may include an action involving attacking, defending, or recovering. In the first type of competition, all of the characters in the group involved in the competition perform an action, such as attacking, defending, or recovering, by exercising their individual normal techniques in the first game space, so as to acquire scores. The first game space is a stage where the groups compete against each other in the first type of competition, and may be referred to as a virtual space or a game field. The first game space is a virtual space or a game field where each character can move freely. The second type of competition is a competition game that may include the first type of competition (i.e., a competition game in the first game space). When either group satisfies a predetermined condition during the game, a great technique (i.e., a second type of technique (also referred to as “second technique” hereinafter)) associated with a character in the group that has satisfied the predetermined condition is exercised in the second type of competition. In one example, the second type of competition is a competition game in which, when the first type of competition is performed during the second type of competition and either of the groups satisfies the predetermined condition upon completion of the first type of competition, all of the characters in the first game space in the first type of competition move to a second game space associated with each character in the group that has satisfied the predetermined condition, so as to compete in the second game space. In another example, the second type of competition may be a competition game in which, when a condition determiner 256 determines that either of the groups satisfies the predetermined condition before the start of a competition round, all of the characters in the group involved in the competition compete in the second game space when the competition round starts.

The second game space is a stage where the groups compete against each other in the second type of competition, and may be referred to as a virtual space or a game field. The second game space is a virtual space or a game field where each character can move freely. Unlike the first game space, the second game space is a game space (virtual space or game field) associated individually with all of the characters selectable in the game. In the second game space, the group that has satisfied the predetermined condition is advantageous over the group that has not satisfied the predetermined condition. The second game space and each character may be associated with each other in accordance with a table or list in which a second game space ID for identifying the second game space is associated with the corresponding character ID, and the table or list may be stored in the storage device 14. The first game space is not associated with each character and has no relation with the characters. Therefore, the game space of a competition game may be the first game space for any character. In contrast, since the second game space is associated with each character, the character is included in either group of a competition game, and a competition in the second game space is not performed unless the predetermined condition is satisfied. Therefore, the specialness of the character can be enhanced in accordance with the association between the character and the second game space. Each of the first game space and the second game space is a three-dimensional game space, or may alternatively be a two-dimensional game space. The second game space may be the same game field as any of the first game spaces.

### [Game Control Unit]

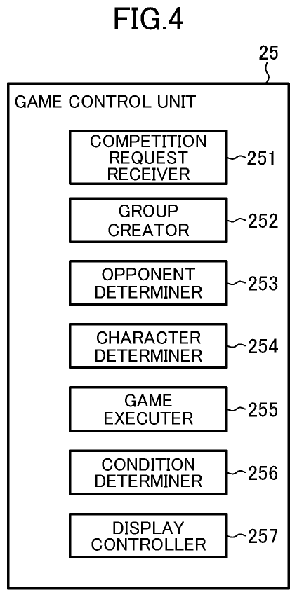

FIG. 4 illustrates an example of a functional block diagram of the game control unit of the server. As shown in FIG. 4, the game control unit 25 includes a competition request receiver 251, a group creator 252, an opponent determiner 253, a character determiner 254, a game executer 255, the condition determiner 256, and a display controller 257.

The competition request receiver 251 is constituted by including the processor 11 and the communication device 14 and receives a competition request from the terminal apparatus 10B of each player. The competition request may include a player ID or may be associated with a player ID.

The group creator 252 is constituted by including the processor 11 and creates a group involved in competition. For example, the group creator 252 creates a group based on a predetermined number of competition requests among competition requests received by the competition request receiver 251. In detail, the group creator 252 stores a player ID and a group ID related to each competition request in association with each other in the storage device 14. For example, if one group is constituted of three characters, the group creator 252 creates one group based on three competition requests and creates another one group based on another three competition requests. A group creating process may involve creating a group by associating players ID of participants, such as friends, associates, or acquaintances, with a group ID, or creating a group by associating player IDs of strangers with a group ID.

The opponent determiner 253 is constituted by including the processor 11 and determines groups that are to participate in a competition from among the created groups. In one example, the opponent determiner 253 determines competition participating groups by lottery (randomly) from among the created groups. Another example involves determining competition participating groups in accordance with a designation of an opponent group (e.g., an input of a desired group ID for the competition) by a certain group. The competition may be a competition between two groups or may be a competition among three or more groups. In this embodiment, a competition between two groups will be described. In another example, the opponent determiner 253 may determine a group as an opponent in accordance with a tournament or league competition. A group participating in a tournament or league competition may be determined by lottery or by designation of the group from among the created groups.

The character determiner 254 is constituted by including the processor 11 and determines a character to be controlled by the player in response to selection of the character by the player. The storage device 14 has stored therein characters selectable in the game. Each character is associated with a character ID, various parameters, such as attacking power and defensive power, the first technique, the level of the first technique, the second technique, and the second game space. The terminal apparatus 10B of each player displays a selectable character group and receives selection of a character from the player. The character determiner 254 receives this selection from the terminal apparatus 10B and determines the character of the player based on the selection. For all of the players in the group involved in the competition, the character determiner 254 determines the characters based on the players' selection.

The game executer 255 is constituted by including the processor 11, and executes a competition game in the first game space or the second game space and generates game-execution-result information. The game-execution-result information includes various types of information required for generating a game screen at the display controller 257, and is transmitted to the display controller 257 by the game executer 255. The game-execution-result information may include information and data about the movement and parameters of each character.

The execution of a competition game will now be described in detail. The game executer 255 executes an operation of a character in the first game space or the second game space based on an operation input by the player via the input device 12, such as a controller, of the terminal apparatus 10B. For example, the game executer 255 executes an action based on an operation input by the player. The action may include any of various actions, such as moving, attacking, defending, and recovering. The actions, such as moving, attacking, defending, and recovering, can be executed mutually in the first game space and the second game space, except for an action (e.g., special technique included in the second technique) executable only in the second game space, and/or mutually in the first type of competition and the second type of competition.

Based on an operation input by the player for commanding the character to move, the game executer 255 executes a process for causing the character to move in the first game space and/or the second game space.

Based on an operation input by the player, the game executer 255 executes an action, such as attacking, moving, or recovering, in the first game space and/or the second game space and changes various parameters of the corresponding character based on the action. By attacking, it is possible to damage the enemy character. Specifically, the game executer 255 attacks the enemy character of the player's character based on an operation input by the player, determines the amount of damage inflicted on the enemy character based on the attacking power of the character (or the relationship between the attacking power of the character and the defensive power of the enemy character), and decreases the stamina parameter of the enemy character by the amount of damage. By defending, damage caused by an attack from the enemy character can be avoided or reduced. The game executer 255 defends the player's character against an attack from the enemy character based on an operation input by the player, determines the amount of damage in the character based on the defensive power of the character (or the relationship between the defensive power of the character and the attacking power of the enemy character), and decreases the stamina parameter of the character by the amount of damage. The amount of damage may be zero. By recovering, the stamina parameter of the target character can be increased. The character serving as the recovery target may be the character executing the recovering action or may be another character in the same group as the character executing the recovering action.

Each of the actions, such as attacking, defending, and recovering, can be performed by using the first technique (normal technique), the special technique included in the second technique, or an item. The first technique, the special technique included in the second technique, or the item can be used in response to an operation performed on the touch panel or a button of, for example, the controller. The first technique may include a technique with an unlimited exercisable number of times and a technique with a limited exercisable number of times. A technique with an unlimited exercisable number of times can be exercised any number of times during a competition game. A technique with a limited exercisable number of times can be exercised a predetermined number of times (e.g., three times). After being exercised the predetermined number of times, the technique with the limited exercisable number of times may be set to a non-exercisable mode until the end of the competition or may be set in the exercisable mode the predetermined number of times again after a predetermined time period (e.g., 15 seconds).

The game executer 255 can determine scores based on the number of enemy characters defeated, the amount of damage inflicted, the exercise of the first technique, the exercise of the special technique, the number of recovery times of an ally character (another character in the same group), the amount of recovery, the time period in which an area in the first game space is occupied, the achievement of a mission, and a victory in a competition round. The game executer 255 calculates a total score determined in the competition round and determines a round score of the competition round. A round score is a total score of the scores acquired by each group in the competition round. The method for determining each score and the score value thereof are not limited to the above and may be designed and changed, where appropriate.

The game executer 255 determines the win-loss result of the competition round based on the magnitude of the round score. In detail, the game executer 255 determines a group with the higher round score as the winner group of the competition round and determines a group with the lower round score as the loser group of the competition round. Furthermore, the game executer 255 determines an ultimate winner group. In one example, the game executer 255 determines a group with the larger number of wins in competition rounds as the ultimate winner group, and determines a group other than the ultimate winner group as the ultimate loser group. In another example, the game executer 255 determines a group with the larger total value of round scores as the ultimate winner group, and determines a group other than the ultimate winner group as the ultimate loser group.

As described above, the game according to this embodiment includes a plurality of competition rounds. Each competition round includes a first type of competition and a second type of competition, and may be set to either of the two. The game executer 255 may receive a designation of either of the first type of competition and the second type of competition by a group (or player) before the start of a competition round. In this embodiment, in one set of competition games each including a plurality of competition rounds, the number of times the second type of competition is designatable by each group is limited to within a predetermined number of times (e.g., once) for the group. Furthermore, in this embodiment, when either of the groups designates the second type of competition in a certain competition round, the other group cannot designate the second type of competition in that competition round. Specifically, in a competition round where the second type of competition is designated, the group that has designated the second type of competition has a chance to exercise the second technique, whereas the other group is not given a chance to exercise the second technique. If two or more groups designate the second type of competition in a certain competition round, an adjustment may be made between the groups by using communication means, such as a chat, inside or outside of the game, or the game executer 255 may determine by lottery which group can designate the second type of competition. The number of times the second type of competition can be designated does not have to be limited, such that the second type of competition may be designatable in the same competition round by either of the groups.

Before the start of a competition round, the game executer 255 may receive a designation of the competition round where the condition determiner 256 executes determination, designation of a group serving as a determination target for the condition determiner 256, and/or designation of a character serving as a determination target for the condition determiner 256. Each of these types of designation is designation by a player or a group. The game executer 255 notifies the condition determiner 256 of the received designation.

The competition round where the condition determiner 256 executes the determination is a competition round in which the second type of competition is designated as the competition in the competition round. Specifically, the game executer 255 notifies the condition determiner 256 that the competition round in which either of the groups has designated the second type of competition as the competition in the competition round is the competition round in which the condition determiner 256 executes the determination.

The group serving as the determination target for the condition determiner 256 is a group that has designated the second type of competition as the competition in the competition round. Specifically, the game executer 255 notifies the condition determiner 256 that the group that has designated the second type of competition as the competition in the competition round is the group serving as the determination target.

The character serving as the determination target for the condition determiner 256 is a character designated by the player or the group from among the characters in the group that has designated the second type of competition in the competition round designated as the second type of competition. Specifically, the game executer 255 notifies the condition determiner 256 of the character designated from among the characters in the group that has designated the second type of competition. This designated character is a character capable of exercising the second technique (also referred to as “second-technique exercising character” hereinafter) in accordance with the determination by the condition determiner 256. From each player in the group that has designated the second type of competition as the competition round, the game executer 255 may receive, via the corresponding terminal apparatus 10B, a designation for setting each operated character as a second-technique exercising character or as a support character supporting the second-technique exercising character. A support character is a character that performs support, such as protecting the second-technique exercising character from an attack by a character in the enemy group in the second type of competition.

Before the start of a competition round, the game executer 255 determines whether to execute a competition game of either of the first type of competition or the second type of competition based on an input from a group or a player. For example, if there is no designation for the second type of competition from either group, the game executer 255 may set the competition round as the first type of competition. If the game executer 255 receives a designation for the second type of competition from either group, the game executer 255 may set the competition round as the second type of competition. In the first type of competition, each character in each group competes in the first game space. The first game space is not associated with any of the characters. In the first type of competition, the game executer 255 executes an action, such as moving, attacking, defending, or recovering, based on an operation input by the player using the first technique (normal technique) and/or an item, and changes the various parameters of a character corresponding to the action.

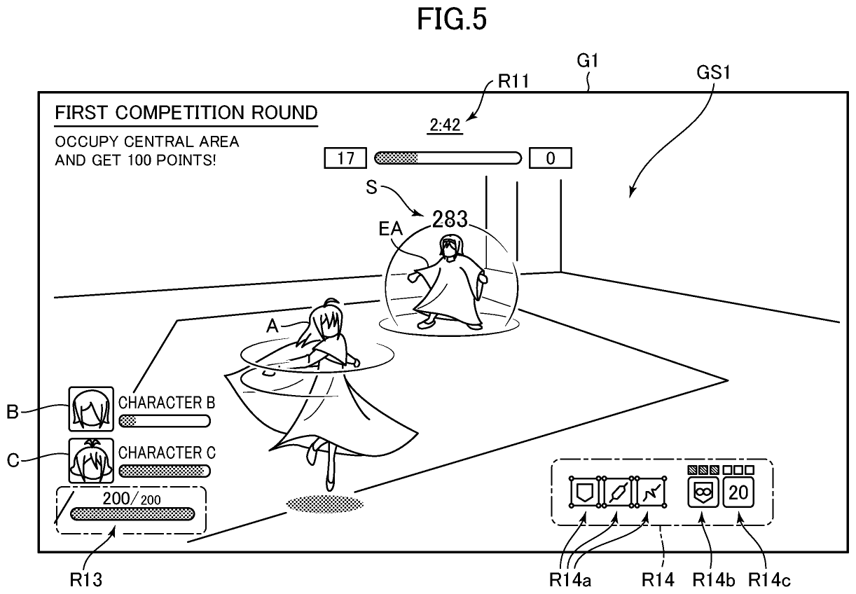

FIG. 5 illustrates an example of a game screen indicating that the competition round is the first type of competition and involves competition in the first game space. The example shown in FIG. 5 indicates a game screen G1 displayed on the output device 13 (display device) of the terminal apparatus 10B by the display controller 257 based on the game-execution-result information obtained by the game executer 255. In the scene of the example shown in FIG. 5, a character A has attacked an enemy character EA in the opponent group in a first game space GS1 and has acquired a score S of 283. On the game screen G1, the first game space GS1 is displayed on the entire screen, and the character A operated by the player within the first game space GS1 and another character (e.g., another character B or C in the ally group and/or a character EA, EB, or EC in the enemy group (opponent group)) may be displayed. The game screen G1 also includes a remaining time R11, ally information R12, a stamina meter R13, and operational information R14. The remaining time R11 is the remaining time for the first type of competition (competition round). Specifically, the first type of competition is provided with a time limit, and the remaining time R11 decreases as time lapses from the start of the first type of competition. In the example shown in FIG. 5, the remaining time R11 is 2 minutes and 42 seconds. The remaining time R11 may be changed by the game executer 255.

The ally information R12 may include the name, image, and meter indication of the stamina parameter of another character (in this case, the character B or C) in the same group (ally group) as the operated character (in this case, the character A). The stamina meter R13 is a meter indication of the remaining stamina parameter of the character A. The operational information R14 may include information about the first technique (normal technique) of the character A and operation buttons for the technique. The operational information R14 may include unlimited-exercisable-technique information R14a, limited-exercisable-technique information R14b, and limited-exercisable-technique information R14c. The unlimited-exercisable-technique information R14a is information about a technique with an unlimited exercisable number of times, and may indicate the details of the technique by means of an image, as well as the level of the technique and an operation button thereof in association with each other. Each of the limited-exercisable-technique information R14b and the limited-exercisable-technique information R14c is information about a technique with a limited exercisable number of times, and may indicate the details of the technique by means of an image, as well as the level of the technique and an operation button thereof in association with the image of the technique. A limited exercisable technique may be exercisable only a predetermined number of times, or may be set to a non-exercisable mode for a predetermined time period after being exercised the predetermined number of times and be subsequently set to an exercisable mode again for the predetermined number of times. In the example shown in FIG. 5, the limited-exercisable-technique information R14b and the limited-exercisable-technique information R14c each indicate that the limited exercisable technique is exercisable three times. The limited-exercisable-technique information R14b indicates that the limited exercisable technique is exercisable three times, whereas the limited-exercisable-technique information R14c indicates a non-exercisable mode. The limited-exercisable-technique information R14c indicates that the limited exercisable technique is exercisable again the predetermined number of times by waiting for 20 seconds.

In this embodiment, the first type of competition is provided with a time limit, and the game executer 255 changes, for example, a remaining time parameter for the time limit as time lapses. When the remaining time parameter reaches zero, the game executer 255 can end the first type of competition. The end of the second type of competition will be described later.

When the second type of competition is designated by any group or player before the start of a competition round, the game executer 255 executes a competition game of the second type of competition. The second type of competition includes a second-technique-exercising battle, and may include competition in the second game space when the condition determiner 256 determines that a predetermined condition is satisfied. The second-technique-exercising battle is a competition in the first game space for exercising the second technique, and may basically be similar to the first type of competition. However, in the second-technique-exercising battle, the game executer 255 may slow down the movement of the second-technique-exercising character relative to the movement of the character in the first type of competition and/or the movement of a character in a group that does not include the second-technique exercising character. Accordingly, the second-technique exercising character may be readily attacked by a character in the opponent group. A support character blocks this attack and/or protects the second-technique exercising character from this attack. The game executer 255 may limit normal techniques exercisable by the second-technique exercising character to some of the normal techniques. The game executer 255 may set the normal techniques of the support character and the character in the opponent group not including the second-technique exercising character to an exercisable mode similarly to the first type of competition.

The game executer 255 executes a competition game of the second-technique-exercising battle within the time limit. The time limit is, for example, a predetermined time period from the start of a competition round and may be set to, for example, three minutes. However, the time limit is not limited to this, and may be set and changed, where appropriate.

If the condition determiner 256 determines that the designated group satisfies the predetermined condition at the end of the second-technique-exercising battle, the game executer 255 executes a process for causing a character in the group having undergone the determination to exercise the second technique (great technique). Specifically, the game executer 255 executes a competition game where the groups compete against each other in the second game space, associated with the character in the group having undergone the determination, in place of the first game space of the second-technique-exercising battle, and executes a favoring process for favoring the group that has satisfied the predetermined condition in the competition game in the second game space. For example, based on the character ID of the designated second-technique exercising character and the table in which the character ID and the ID of the second game space are associated with each other, the game executer 255 reads data about the second game space of the second-technique exercising character from the storage device 14, and executes a competition game in the second game space including the favoring process. Accordingly, by exercising the second technique, all of the characters in the group involved in the competition are moved from the first game space to the second game space, thereby creating a favorable condition for the group that has satisfied the predetermined condition.

The second game space is a game space associated with each character. The second game space may be a game space unique to the second-technique exercising character. Alternatively, the same second game space may be associated with a plurality of characters.

The favoring process may include an arbitrary process so long as it is a process that favors the group that has satisfied the predetermined condition. For example, the favoring process may include a process (1) for significantly increasing the attacking power and/or the defending power of a character in the group (also referred to as “ally group”) that has satisfied the predetermined condition, a process (2) for not decreasing or reducing the amount of decrease in the stamina parameter of the character in the ally group in response to an attack from a character in a group (also referred to as “enemy group”) that has not satisfied the predetermined condition, a process (3) for maintaining the stamina parameter of the character in the ally group even if the character in the enemy group cannot attack or has attacked, a process (4) for reducing a score value, which should be calculated in accordance with an action of the enemy group, relative to a preset value or for setting the score value to zero, and a process (5) for setting the character in the ally group at a favorable position or area and setting the character in the enemy group at an unfavorable position or area (e.g., setting the character in the ally group at a position or area where the character in the ally group can easily attack the character in the enemy group and setting the character in the enemy group at a position or area where the character in the enemy group is readily attacked by the character in the ally group, or setting the character in the ally group at a position or area where the character in the ally group can easily acquire a weapon or item that allows the character in the ally group to proceed with the game more advantageously than the character in the enemy group). Accordingly, the favoring process involves setting the group or character that has satisfied the predetermined condition to an invincible state. The favoring process may be applied by including at least a character that has exercised the second technique in the group that has satisfied the predetermined condition.

The favoring process may include a process for executing a technique exercisable only in the second game space based on an input from the player associated with the character in the group that has satisfied the predetermined condition. A technique exercisable only in the second game space is a special technique included in the second technique and is stored in the storage device 14 in association with either every character or every second game space. Although the special technique is preferably unique to each character, the same special technique may be associated with a plurality of characters. An amount of parameter variation caused by the special technique may be larger than an amount of parameter variation caused by the normal technique. The special technique may be unlimited in terms of the exercisable number of times. Based on an operation input by the player, the game executer 255 exercises the special technique, determines the amount of variation in the stamina parameter associated with the special technique, and decreases the stamina parameter of the character in the enemy group serving as an attacking target by the determined amount of variation. Accordingly, the favoring process can cause the group that has satisfied the predetermined condition to be predominantly advantageous. Therefore, the exercising of the second technique may reverse the situation of the game or may greatly affect the win-loss result of the game.

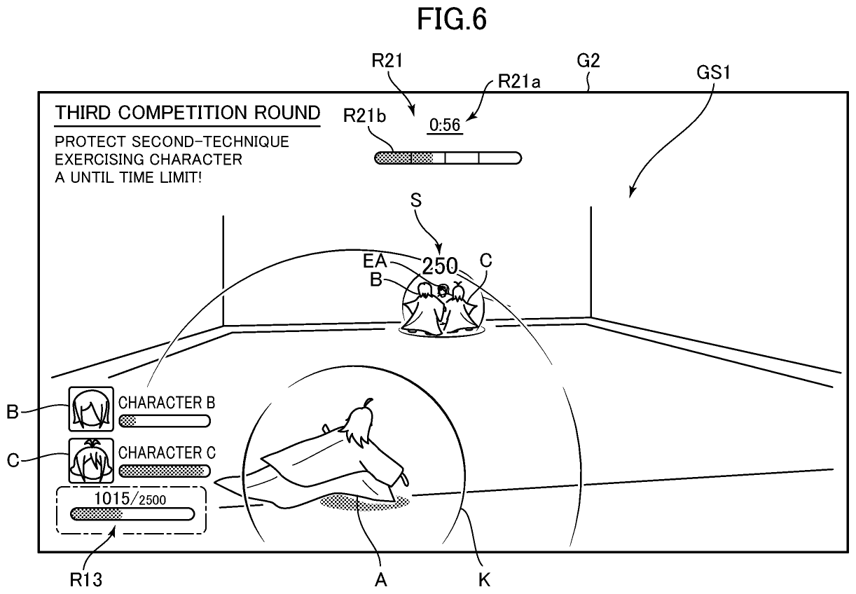

FIG. 6 illustrates an example of a game screen indicating that the competition round is the second type of competition and involves competition in the first game space before it is determined whether the predetermined condition is satisfied. When the second type of competition is designated, the game executer 255 executes a competition game in the second-technique-exercising battle of a designated character. The example shown in FIG. 6 indicates a game screen G2 displayed on the output device 13 (display device) of the terminal apparatus 10B by the display controller 257 based on the game-execution-result information obtained by the game executer 255. The game screen G2 shows the competition game in the second-technique-exercising battle. The game screen G2 may include predetermined condition information R21, the ally information R12, the stamina meter R13, and the operational information R14. The predetermined condition information R21 includes a condition for exercising the second technique. The predetermined condition information R21 includes a remaining time R21a and a stamina meter R21b. The remaining time R21a is the remaining time for the second-technique-exercising battle to continue. In the example shown in FIG. 6, there are 56 seconds remaining. The stamina meter R21b is a meter indication of the remaining stamina parameter of the second-technique exercising character. The remaining stamina parameter of the second-technique exercising character may display a sphere around the character. In the example shown in FIG. 6, a sphere K is displayed around the second-technique exercising character A. The size (e.g., radius) of the sphere K may indicate the remaining stamina parameter. For example, the stamina parameter remaining may decrease with decreasing size of the sphere K.

The game executer 255 according to this embodiment executes the competition game in the second-technique-exercising battle until the remaining time R21a reaches zero or the remaining stamina parameter of the second-technique exercising character reaches zero, whichever comes earlier. The ally information R12 and the stamina meter R13 in FIG. 6 are identical to the ally information R12 and the stamina meter R13 in FIG. 5. As shown in FIG. 6, the operational information R14 does not have to be displayed on the game screen G2 to the player using the second-technique exercising character, and may be displayed on the game screen G2 to players using a support character and a character in a group not serving as a determination target for the condition determiner 256. In the second-technique-exercising battle, the game executer 255 may set some of the normal techniques of the second-technique exercising character to an executable mode and set the remaining normal techniques to a non-executable mode. In the second-technique-exercising battle, the game executer 255 may slow down the movement of the second-technique exercising character based on a player's operation, as compared with the movement thereof in the first type of competition or the movement of another character. By relatively reducing the movement rate of the second-technique exercising character in this manner, a character in the opponent group can readily attack the second-technique exercising character, thereby heating up the second-technique-exercising battle.

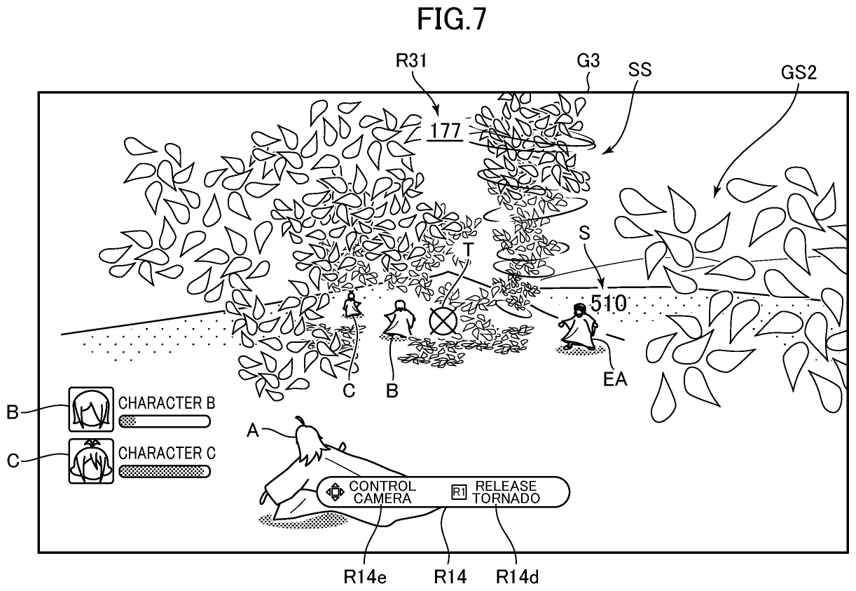

FIG. 7 illustrates an example of a game screen indicating that the competition round is the second type of competition and involves competition in the second game space when the predetermined condition is satisfied. As shown in FIG. 7, when the condition determiner 256 determines that either of the groups has satisfied the predetermined condition, the game executer 255 causes all of the characters in the ally and enemy groups to move from the first game space to the second game space associated with each character in the group that has satisfied the predetermined condition, and executes a competition game in the second game space. Specifically, with the predetermined condition being satisfied, the game executer 255 switches game-field data from first-game-space data to second-game-space data. The switching of the game spaces by the game executer 255 may involve replacing all data about the game space or replacing some data about the game space. Alternatively, image processing for partially or entirely changing the display mode of the game space is also possible.

A game screen G3 shown in FIG. 7 indicates competition in the second game space when the predetermined condition is satisfied, and the characters in the group involved in the competition have moved to a second game space GS2.

In the second game space, each character in the group that has satisfied the predetermined condition can execute a special technique. Specifically, the game executer 255 executes the special technique based on an operation input by the player using the character in the group that has satisfied the predetermined condition. In the example shown in FIG. 7, a special technique SS is a technique for “releasing a tornado”. In the example shown in FIG. 7, the game screen G3 displays the operational information R14, and the operational information R14 includes a special-technique-information indication R14d and a camera-operational-information indication R14e. The special-technique-information indication R14d includes the name of the special technique and an operation button for the special technique. The camera-operational-information indication R14e includes an operation button of a target T for controlling a direction and/or a position for exercising the special technique. The target T can be moved to a desired position by using a predetermined button and a numerical keypad of the controller connected to the terminal apparatus 10B.

Although the game executer 255 allows only the designated character in the group that has satisfied the predetermined condition to exercise the special technique, the game executer 255 may allow all of the characters in the group that has satisfied the predetermined condition to exercise the special techniques associated with the respective characters.

The game executer 255 ends the competition game in the second game space in a predetermined case. In one example, the game executer 255 may end the competition game after a predetermined time period from the start of the competition game in the second game space. In another example, the game executer 255 may end the competition game after the predetermined time period from the start of the competition game in the second game space, and may execute the competition game in the first game space. In yet another example, the game executer 255 may end the competition game in the second game space when all of the characters in the enemy group are defeated. In another example, the game executer 255 may execute the competition game in the second game space, increase or decrease limitation points in accordance with the status of the competition game, and end the competition game in the second game space when the limitation points decrease to a predetermined value. In the example shown in FIG. 7, the game screen G3 displays limitation points R31. Although the limitation points R31 are displayed at the center of the upper part of the game screen G3, the display location can be set and changed, where appropriate.

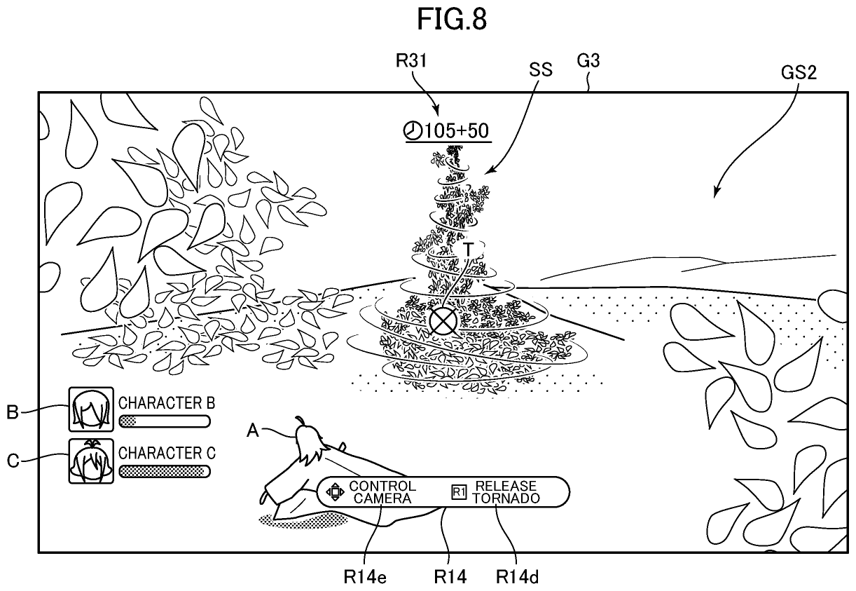

The limitation points can be increased and decreased in accordance with the status of the competition game in the second game space. The game executer 255 can decrease the limitation points as time lapses from the start of the competition game in the second game space. The game executer 255 may increase the amount of decrease in the limitation points as time lapses from the start of the competition game in the second game space. The game executer 255 may increase the limitation points. In an example shown in FIG. 8, 50 bonus points are added to 105 limitation points. The game executer 255 may increase the limitation points every time a character in the group that has satisfied the predetermined condition (e.g., the second-technique exercising character or at least one character in the group) defeats an enemy character. The game executer 255 may decrease the amount of increase in the limitation points as the number of enemy characters defeated increases and/or as time lapses. The mode for increasing and decreasing the limitation points may be an individual and arbitrary combination of the aforementioned modes.

Accordingly, the game executer 255 basically performs a change to decrease the limitation points, and ends the competition game in the second game space when the limitation points decrease to a predetermined value (e.g., zero). Even when the limitation points temporarily increase, the amount of increase gradually decreases, and then the amount of decrease gradually increases, so that the competition game in the second game space can be terminated. The game executer 255 may change the display color of the limitation points as the amount of decrease or the rate of decrease in the limitation points increases.

In this embodiment, the game executer 255 ends the competition game of the second type of competition with the end of the competition game in the second game space. Alternatively, the game executer 255 may execute a competition game of the first type of competition after the end of the competition game in the second game space. In this case, the game executer 255 causes all of the characters involved in the competition to move from the second game space to the first game space. This competition in the first game space may be within a predetermined time limit.

The condition determiner 256 is constituted by including the processor 11 and determines whether or not either of the groups satisfies the predetermined condition during the game.

The predetermined condition may include any of (1) to (5) indicated below, or may include a combination of two or more of (1) to (5).
(1) A competition round in which the condition determiner 256 executes the determination is designated.
(2) A group serving as a determination target for the condition determiner 256 is designated before the start of the competition round.
(3) A character serving as a determination target for the condition determiner 256 is designated before the start of the competition round.
(4) A predetermined parameter that is of the character designated as the determination target for the condition determiner 256 before the start of the competition round and that varies in accordance with an attack by a character in another group different from the group of the designated character is larger than or equal to a predetermined value before a predetermined time period lapses from the start of the competition round.
(5) The number of times the determination is performed by the condition determiner 256 is within a predetermined number of times for each group.

The predetermined parameter that varies in accordance with an attack by a character in another group different from the group of the designated character in condition (4) indicated above may be, for example, the stamina parameter. The number of times the determination is performed in condition (5) indicated above is the number of times conditional determination is performed in the past in competition. The predetermined number of times in condition (5) may be, for example, once, but is not limited thereto. If the predetermined number of times is once, the determination is performable only in any one of the multiple competition rounds constituting the game.

The condition determiner 256 determines that the predetermined condition is satisfied when all of the conditions included in the predetermined condition are satisfied. In contrast, the condition determiner 256 determines that the predetermined condition is not satisfied if any of the conditions included in the predetermined condition is not satisfied. The condition determiner 256 may count the number of times the determination of whether or not the predetermined condition is satisfied is performed as the number of times conditional determination is performed, and store the number of times for each group in the storage device 14.

The timing at which the condition determiner 256 performs the conditional determination may be on or after the timing corresponding to the latest determinable condition among the conditions included in the predetermined condition. For example, if the predetermined condition includes conditions (1) to (5) indicated above, condition (4) is the latest determinable condition. This is because conditions (1) to (3) and (5) are determinable before the start of the competition round, whereas condition (4) is only determinable after the start of the competition round. The condition determiner 256 may determine each of the conditions included in the predetermined condition at the timing when the condition becomes determinable. In this case, if any of the conditions included in the predetermined condition is not satisfied, the condition determiner 256 may determine at that time point that the predetermined condition is not satisfied. The determination of whether the predetermined condition is satisfied is performed on or after the timing corresponding to the latest determinable condition among the conditions included in the predetermined condition. If the condition determiner 256 determines that condition (5) indicated above is not satisfied, the game executer 255 may be configured not to receive a designation of each of conditions (1) to (3).

The predetermined condition according to this embodiment includes all of conditions (1) to (5) indicated above. Therefore, the determination by the condition determiner 256 may be executed during the second type of competition. For example, the condition determiner 256 may determine whether the predetermined condition is satisfied at the end of the second-technique-exercising battle of the second type of competition.

The display controller 257 is constituted by including the processor 11 and causes the output device 13 (display device) connected to the server 10A to display the competition game. In this embodiment, the output device 13 is the output device 13 of the terminal apparatus 10B connected to the server 10A via the network 60. The display controller 257 generates various game screens (e.g., the game screens G1 to G3) based on the game-execution-result information obtained by the game executer 255, and causes the output device 13 of the terminal apparatus 10B to display each game screen. The display controller 257 generates each game screen including a character operated by each player. In other words, the game screens displayed on the output devices 13 of the individual terminal apparatuses 10B have different points of view.

When the condition determiner 256 determines that either group satisfies the predetermined condition during the game, the display controller 257 causes the output device 13 of each terminal apparatus 10B to display a competition game where the groups compete against each other in the second game space. In this case, the display controller 257 may cause the output device 13 of each terminal apparatus 10B to display the limitation points that increase or decrease in accordance with the status of the competition game in the second game space.

### [Operation]

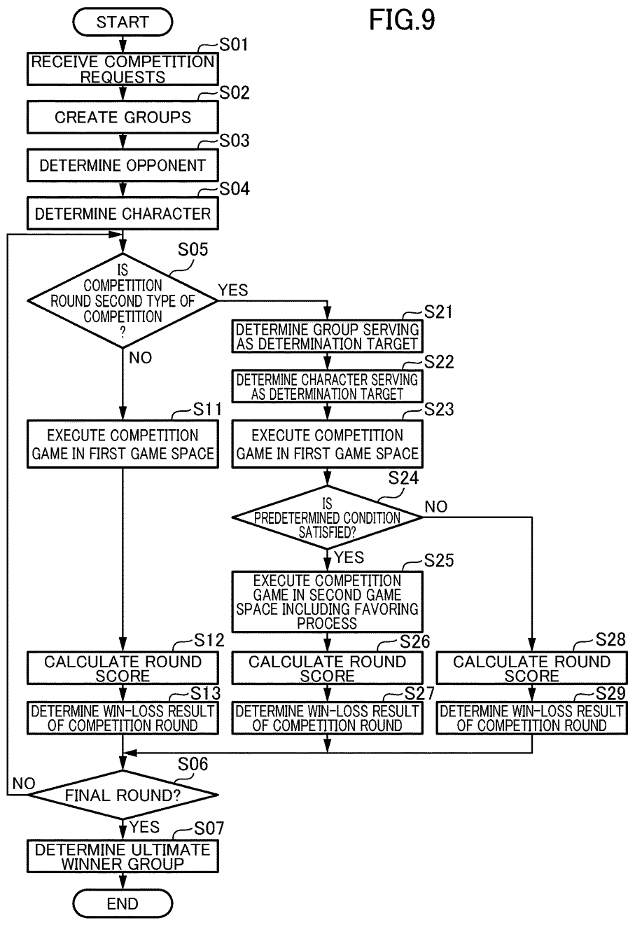

The operation of the game system 1 according to an embodiment of the present invention will now be described. FIG. 9 illustrates an example of an operation flowchart of the game system 1 according to the embodiment of the present invention.

The server 10A causes the competition request receiver 251 to receive a competition request based on a player's input from each terminal apparatus 10B (S01: receive competition requests). Then, the server 10A causes the group creator 252 to create groups involved in the competition (S02: create groups). Based on the competition request received from each of the terminal apparatuses 10B of six players, the group creator 252 creates one group I for three players and creates another group II for the other three players. The group creator 252 stores each group ID and player IDs of the players belonging to the group in association with each other in the storage device 14.

The server 10A causes the opponent determiner 253 to determine a group that is to participate in the competition from among the created groups (S03: determine opponent). In this case, the opponent determiner 253 sets a competition between group I and group II.

Subsequently, the server 10A causes the game executer 255 to start the game and determine whether the competition round is the second type of competition (S05: is competition round second type of competition?). This determination can be executed based on whether or not the game executer 255 has received a designation for setting the competition round to the second type of competition from the group or player.

If the game executer 255 does not receive a designation for setting the competition round to the second type of competition from the group or player before the start of the competition round (NO in S05), the game executer 255 determines that the competition round is the first type of competition and executes a competition game in the first game space (S11: execute competition game in first game space). The game executer 255 sums up the score acquired by each group during the game for every group, so as to calculate the round score of each group (S12: calculate round score). The game executer 255 may store the calculated round score in the storage device 14. The game executer 255 determines the win-loss result of the competition round by determining that the group with the higher round score is the winner group (S13: determine win-loss result of competition round). The game executer 255 increments a victory count parameter for the group determined as the winner group and stores the victory count parameter in the storage device 14.

If the game executer 255 receives a designation for setting the competition round to the second type of competition from the group or player before the start of the competition round (YES in S05), the game executer 255 determines a group serving as a determination target for the condition determiner 256 (S21: determine group serving as determination target), and determines a character serving as a determination target for the condition determiner 256 (S22: determine character serving as determination target).

In this embodiment, the game executer 255 determines that the group that has designated the second type of competition is the group serving as the determination target for the condition determiner 256, and determines that the character designated by the player in the group or by the group is the character serving as the determination target for the condition determiner 256. This designated character is a character (second-technique exercising character) that may exercise the second technique. A character other than the second-technique exercising character in the group is set as a support character that serves as a supporter, such as a guard, for the second-technique exercising character.

The game executer 255 receives the designation of the second-technique exercising character and the support character from each player in the group that has designated the second type of competition as the competition round. This embodiment is provided with limitations where one character can be set as the second-technique exercising character and the remaining characters are support characters. In a case where multiple players are designated as second-technique exercising characters, in one example, an adjustment is made between the players by using communication means, such as a chat, inside or outside of the game, and the character of either player is set as a second-technique exercising character. In another example, the game executer 255 sets the character of either player as a second-technique exercising character by lottery or at random.

When the competition round, group, and character serving as determination targets are designated or set, the game executer 255 notifies the condition determiner 256 of the designated or set competition round, group, and character. The condition determiner 256 can determine that conditions (1) to (3) and (5) are satisfied when the notifications are received. In this case, the condition determiner 256 determines that conditions (1) to (3) and (5) are satisfied. Alternatively, the determination of the predetermined condition does not have to be performed at this stage.

After the designation, the setting, or the notification, the game executer 255 executes a competition game of the second type of competition. First, the game executer 255 executes the competition game in the first game space (S23: execute competition game in first game space). This competition game may be similar to the first type of competition. In this case, a difference from the competition game of the first type of competition is that at least a condition in which the stamina parameter of the second-technique exercising character within the time limit is larger than or equal to a predetermined value is imposed as one of the predetermined conditions to be determined by the condition determiner 256. The competition game in this case is a second-technique-exercising battle for the second-technique exercising character to exercise the second technique.

The condition determiner 256 determines whether or not the second-technique exercising character in the group that has designated the second type of competition satisfies a predetermined condition (S24: is predetermined condition satisfied?). In this case, if the stamina parameter of the second-technique exercising character in the group that has designated the second type of competition is larger than or equal to a predetermined value (e.g., 1) before the end of the time limit (YES in S24), the condition determiner 256 determines that the predetermined condition is satisfied. The game executer 255 causes all of the characters involved in the competition to move to the second game space associated with the second-technique exercising character and executes a competition game in the second game space (S25: execute competition game in second game space). In this competition game, the game executer 255 executes the favoring process on the character in the group that has designated the second type of competition based on an operation input by the player.

The game executer 255 sums up the score acquired by each group during the game for every group, so as to calculate the round score of each group (S26: calculate round score). The round score may be calculated by adding together the score acquired in the second-technique-exercising battle and the score acquired in the competition in the second game space. The game executer 255 may store the calculated round score in the storage device 14. The game executer 255 determines the win-loss result of the competition round by determining that the group with the higher round score is the winner group (S27: determine win-loss result of competition round). The game executer 255 increments the victory count parameter for the group determined as the winner group and stores the victory count parameter in the storage device 14.

On the other hand, if the condition determiner 256 determines that the stamina parameter of the second-technique exercising character in the group that has designated the second type of competition is below the predetermined value (e.g., zero) before the end of the time limit for the second-technique-exercising battle (NO in S24), the condition determiner 256 determines that the predetermined condition is not satisfied. In this case, the game executer 255 ends the competition game of the second type of competition and sums up the score acquired by each group in the competition game for every group, so as to calculate the round score of each group (S28: calculate round score). The game executer 255 may store the calculated round score in the storage device 14. The game executer 255 determines the win-loss result of the competition round by determining that the group with the higher round score is the winner group (S29: determine win-loss result of competition round). The game executer 255 increments the victory count parameter for the group determined as the winner group and stores the victory count parameter in the storage device 14.

After S13, S27, and S29, if the last competition round for determining the win-loss result is not the final round (NO in S06), the game executer 255 returns to S05 and proceeds to the subsequent competition round. If the last competition round for determining the win-loss result is the final round (YES in S06), the game executer 255 determines an ultimate winner group (S07: determine ultimate winner group) and ends the game. For example, the game executer 255 determines that the group with the larger number of competition rounds won (processing count parameter) is the ultimate winner group, and determines that an otherwise group is the ultimate loser group.

### Effects and Advantages

[1] The game system 1 according to this embodiment is a system that executes a game that involves competition between groups including a plurality of characters. The system has a plurality of information processing apparatuses 10. At least one of the information processing apparatuses 10 functions as a game executer 255 that executes a competition game where the groups compete against each other in a first game space, and at least one of the information processing apparatuses 10 functions as a condition determiner 256 that determines whether or not either of the groups satisfies a predetermined condition during the game. When the condition determiner 256 determines that either of the groups satisfies the predetermined condition during the game, the game executer 255 executes a competition game where the groups compete against each other in a second game space that is associated with each character in the group determined as having satisfied the predetermined condition and that is different from the first game space, and executes a favoring process on the group that has satisfied the predetermined condition in the competition game.

Accordingly, a favorable condition occurs in the second game space associated with the character in the group determined as having satisfied the predetermined condition, so that the character is endowed with specialness, thereby enhancing the enjoyment of the game.
[2] The game includes a plurality of competition rounds each involving execution of a competition game, and the predetermined condition includes a state where a competition round in which the condition determiner 256 executes the determination is designated. Accordingly, the competition round that may cause a favorable condition to occur in the second game space is set, thereby heating up the competition game to fight over the occurrence of the favorable condition in the second game space.
[3] The predetermined condition includes a state where a group serving as a determination target is designated before the start of the competition round. Accordingly, the group that may cause a favorable condition to occur in the second game space is set, thereby heating up the competition game to fight over the occurrence of the favorable condition in the second game space.
[4] The predetermined condition includes a state where a character serving as a determination target is designated before the start of the competition round. Accordingly, the character that may cause a favorable condition to occur in the second game space is set, thereby heating up the competition game to fight over the occurrence of the favorable condition in the second game space.
[5] The predetermined condition includes a state where a predetermined parameter that is of the designated character and that varies in accordance with an attack by a character in another group different from the group of the designated character is larger than or equal to a predetermined value before a predetermined time period lapses from the start of the competition round.

Accordingly, competition in the competition round can be set as a second-technique-exercising battle, and the enjoyment of the game can be enhanced for the player in each group. Specifically, for a group not including a designated character, since the occurrence of a favorable condition can be prevented by reducing a predetermined parameter (e.g., stamina parameter) of the designated character (second-technique exercising character) to below a predetermined value, there is a desire to reduce the stamina parameter of the designated character. In contrast, for a group including a designated character, there is a desire to not reduce the predetermined parameter of the designated character. Accordingly, this embodiment can give rise to opposing desires of the two groups, so that the competition in the competition round can be a battle fighting over whether or not a favorable condition occurs in the second game space, thereby further heating up the competition.
[6] The predetermined condition includes a state where the number of times the determination is performed is smaller than or equal to a predetermined number of times for each group. Accordingly, the number of times a favorable condition occurs in the second game space can be limited, so as to make the player or group think of a strategy for causing a favorable condition to occur in which of the competition rounds, thereby enhancing the enjoyment of the game.
[7] The favoring process includes executing a technique exercisable only in the second game space based on an input by a player associated with a character in the group that has satisfied the predetermined condition. Accordingly, this allows specialness to be given to selection of a character, while enabling the game to proceed favorably.
[8] The game executer 255 ends the competition game after a predetermined time period from the start of the competition game in the second game space, or ends the competition game after a predetermined time period from the start of the competition game in the second game space and subsequently executes a competition game in the first game space. Accordingly, the player associated with the group determined as having satisfied the predetermined condition or a character thereof can enjoy a favorable condition in the second game space for a limited period of time.
[9] An information processing apparatus 10 (e.g., server 10A) further has a display controller 257 that causes a display device (output device 13) of another information processing apparatus 10 (e.g., terminal apparatus 10B) or a display device (output device 13) connected to said another information processing apparatus 10 to display a competition game. When the condition determiner 256 determines that either of the groups satisfies the predetermined condition during the game, the display controller 257 causes the display device (output device 13) to display the competition game where the groups compete against each other in the second game space.

Accordingly, with either of the groups satisfying the predetermined condition, each of the players in the groups can ascertain a special situation where all of the characters in each group move to the second game space, which is associated with each character in the group that has satisfied the predetermined condition, and compete therein.
[10) When the condition determiner 256 determines that either of the groups satisfies the predetermined condition during the game, the display controller 257 causes display means to display limitation points that increase or decrease in accordance with the status of the competition game in the second game space. The game executer 255 executes the competition game in the second game space and increases or decreases the limitation points in accordance with the status of the competition game, and ends the competition game in the second game space when the limitation points decrease to a predetermined value.

Accordingly, with the limitation points involved in the termination of the competition game in the second game space, the period of the competition game can be varied while also being limited, thereby enhancing the enjoyment of the competition game in the second game space.
[11) Each character is selectable by a player, and all of the characters selectable in the game are each associated with the second game space unique to the character. Accordingly, each character can be endowed with specialness.

### [Embodiment Achieved by System not Intervened by Network]

In the game system 1, the plurality of information processing apparatuses 10 may communicate with each other in a wired and/or wireless manner without the intervention of the network 60, as in a P2P (peer to peer) system. In this case, all or some of the information processing apparatuses 10 may have the functions of the components 251 to 257. Specifically, one or more of the information processing apparatuses 10 constituting the game system 1 may have the functions of the components 251 to 257 to have the role of the server 10A in the above embodiment. The functions of the components 251 to 257 may be consolidated in a single information processing apparatus 10 or may be distributed to a plurality of information processing apparatuses 10.

### Other Embodiments

In another embodiment of the present invention, a program for implementing the functions and the information processing indicated in the flowchart according to the above-described embodiment of the present invention and a computer-readable storage medium storing the program are also possible. In yet another embodiment, a method for implementing the functions and the information processing indicated in the flowchart according to the above-described embodiment of the present invention is also possible. In yet another embodiment, a server capable of supplying a computer with the program for implementing the functions and the information processing indicated in the flowchart according to the above-described embodiment of the present invention is also possible. In yet another embodiment, a virtual machine for implementing the functions and the information processing indicated in the flowchart according to the above-described embodiment of the present invention is also possible.

In the processing or operation described above, the processing or operation may be changed freely in a certain step so long as there is no contradiction in the processing or operation, such as the use of data that should not be usable yet in that step. The embodiments described above are examples for describing the present invention, and the present invention is not limited to these embodiments. The present invention may be implemented in various modes so long as they do not depart from the gist thereof.

For example, as an alternative to the above embodiment in which competition in a competition game involves competition between groups including a plurality of characters, the competition may involve competition between a group including one character and a group including one or more characters. In the case where a group is constituted of one character, the character can be set as the second-technique exercising character, and the group does not have to include a support character.

### REFERENCE SIGNS LIST

1 game system
10 information processing apparatus
10A server
10B terminal apparatus
11 processor
12 input device
13 output device
14 storage device
15 communication device
16 bus
21 input unit
22 output unit
23 storage unit
24 communication unit
25 game control unit
251 competition request receiver
252 group creator
253 opponent determiner
254 character determiner
255 game executer
256 condition determiner
257 display controller
60 network

1. A non-transitory computer readable medium storing a program for executing a game involving competition between groups including a plurality of characters, the program causing a computer to function as:
game executing means for executing a competition game where the groups compete against each other in a first game space; and
condition determining means for executing determination of whether or not either of the groups satisfies a predetermined condition during the game,
wherein when the condition determining means determines that either of the groups satisfies the predetermined condition during the game, the game executing means executes a competition game where the groups compete against each other in a second game space that is associated with each character in the group determined as having satisfied the predetermined condition and that is different from the first game space, and executes a favoring process on the group that has satisfied the predetermined condition in the competition game.

2. The non-transitory computer readable medium according to claim 1,
wherein the game includes a plurality of competition rounds each involving execution of the competition game, and
wherein the predetermined condition includes a state where the competition round in which the condition determining means executes the determination is designated.

3. The non-transitory computer readable medium according to claim 2,
wherein the predetermined condition includes a state where the group serving as a target for the determination is designated before the competition round starts.

4. The non-transitory computer readable medium according to claim 2,
wherein the predetermined condition includes a state where the character serving as a target for the determination is designated before the competition round starts.

5. The non-transitory computer readable medium according to claim 4,
wherein the predetermined condition includes a state where a predetermined parameter that is of the designated character and that varies in accordance with an attack by the character in another group different from the group of the designated character is larger than or equal to a predetermined value before a predetermined time period lapses from when the competition round starts.

6. The non-transitory computer readable medium according to claim 2,
wherein the predetermined condition includes a state where the number of times the determination is performed is smaller than or equal to a predetermined number of times for each group.

7. The non-transitory computer readable medium according to claim 2,
wherein the predetermined condition includes a combination of two or more of:
a state where the group serving as a target for the determination is designated before the competition round starts;
a state where the character serving as a target for the determination is designated before the competition round starts;
a state where a predetermined parameter that is of the character designated as the target for the determination before the competition round starts and that varies in accordance with an attack by the character in another group different from the group of the designated character is larger than or equal to a predetermined value before a predetermined time period lapses from when the competition round starts; and
a state where the number of times the determination is performed is smaller than or equal to a predetermined number of times for each group.

8. The non-transitory computer readable medium according to claim 1,
wherein the favoring process includes executing a technique exercisable only in the second game space based on an input by a player associated with the character in the group that has satisfied the predetermined condition.

9. The non-transitory computer readable medium according to claim 1,
wherein the game executing means ends the competition game after a predetermined time period lapses from when the competition game starts in the second game space, or ends the competition game after a predetermined time period lapses from when the competition game starts in the second game space and subsequently executes the competition game in the first game space.

10. The non-transitory computer readable medium according to claim 1, further causing the computer to function as display control means for causing display means connected to the computer to display the competition game,
wherein when the condition determining means determines that either of the groups satisfies the predetermined condition during the game, the display control means causes the display means to display the competition game where the groups compete against each other in the second game space.

11. The non-transitory computer readable medium according to claim 10,
wherein when the condition determining means determines that either of the groups satisfies the predetermined condition during the game, the display control means causes the display means to display limitation points that increase or decrease in accordance with a status of the competition game in the second game space, and
wherein the game executing means executes the competition game in the second game space, increases or decreases the limitation points in accordance with the status of the competition game, and ends the competition game in the second game space when the limitation points decrease to a predetermined value.

12. The non-transitory computer readable medium according to claim 1,
wherein each character is selectable by a player, and
wherein all of the characters selectable in the game are each associated with the second game space.

13. The non-transitory computer readable medium according to claim 1,
wherein the program has at least one of following configurations [2] and [7] to [12]:
[2] the game includes a plurality of competition rounds each involving execution of the competition game, and
the predetermined condition includes a state where the competition round in which the condition determining means executes the determination is designated;
[7] in the configuration [2], the predetermined condition includes any of or a combination of at least two of
a state where the group serving as a target for the determination is designated before the competition round starts,
a state where the character serving as a target for the determination is designated before the competition round starts,
a state where a predetermined parameter that is of the character designated as the target for the determination before the competition round starts and that varies in accordance with an attack by the character in another group different from the group of the designated character is larger than or equal to a predetermined value before a predetermined time period lapses from when the competition round starts, and
a state where the number of times the determination is performed is smaller than or equal to a predetermined number of times for each group;
[8] the favoring process includes executing a technique exercisable only in the second game space based on an input by a player associated with the character in the group that has satisfied the predetermined condition;
[9] the game executing means ends the competition game after a predetermined time period lapses from when the competition game starts in the second game space, or ends the competition game after a predetermined time period lapses from when the competition game starts in the second game space and subsequently executes the competition game in the first game space;
[10] the computer is further caused to function as display control means for causing display means connected to the computer to display the competition game, and
the display control means causes the display means to display the competition game where the groups compete against each other in the second game space when the condition determining means determines that either of the groups satisfies the predetermined condition during the game;
[11] in the configuration [10], when the condition determining means determines that either of the groups satisfies the predetermined condition during the game,
the display control means causes the display means to display limitation points that increase or decrease in accordance with a status of the competition game in the second game space, and
the game executing means executes the competition game in the second game space, increases or decreases the limitation points in accordance with the status of the competition game, and ends the competition game in the second game space when the limitation points decrease to a predetermined value;
[12] each character is selectable by the player, and
all of the characters selectable in the game are each associated with the second game space unique to each character.

14. An information processing apparatus for executing a game involving competition between groups including a plurality of characters, the information processing apparatus comprising:
game executing means for executing a competition game where the groups compete against each other in a first game space; and
condition determining means for executing determination of whether or not either of the groups satisfies a predetermined condition during the game,
wherein when the condition determining means determines that either of the groups satisfies the predetermined condition during the game, the game executing means executes a competition game where the groups compete against each other in a second game space that is associated with each character in the group determined as having satisfied the predetermined condition and that is different from the first game space, and executes a favoring process on the group that has satisfied the predetermined condition in the competition game.

15. A method in which an information processing apparatus executes a game involving competition between groups including a plurality of characters, the method comprising:
a game executing step for executing a competition game where the groups compete against each other in a first game space; and
a condition determining step for executing determination of whether or not either of the groups satisfies a predetermined condition during the game,
wherein when either of the groups is determined as having satisfied the predetermined condition during the game in the condition determining step, the game executing step involves executing a competition game where the groups compete against each other in a second game space that is associated with each character in the group determined as having satisfied the predetermined condition and that is different from the first game space, and executing a favoring process on the group that has satisfied the predetermined condition in the competition game.

16. A system for executing a game involving competition between groups including a plurality of characters,
wherein the system has a plurality of information processing apparatuses,
wherein at least one of the information processing apparatuses functions as game executing means for executing a competition game where the groups compete against each other in a first game space,
wherein at least one of the information processing apparatuses functions as condition determining means for executing determination of whether or not either of the groups satisfies a predetermined condition during the game,
wherein when the condition determining means determines that either of the groups satisfies the predetermined condition during the game, the game executing means executes a competition game where the groups compete against each other in a second game space that is associated with each character in the group determined as having satisfied the predetermined condition and that is different from the first game space, and executes a favoring process on the group that has satisfied the predetermined condition in the competition game.
